(19) United States
(12) Patent Application Publication
(10) Pub. No.: US 2006/0141255 A1
(43) Pub. Date: Jun. 29, 2006

(54) Security elements and chromophoric security features

(76) Inventors: Matthias Muller, Bechtsrieth (DE); Martin Bergsmann, Leonding (DE); Friedrich Kastner, Grieskirchen (AT); Marco Mayrhofer, Perg (AT)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/560,392

(22) PCT Filed: Jun. 16, 2004
(86) PCT No.: PCT/EP04/06456

§ 371 Date: Dec. 13, 2005

(30) Foreign Application Priority Data
Jun. 18, 2003 (AT) 943/2003

(51) Int. Cl. B32B 5/16; B32B 15/02; B32B 17/02; B32B 19/00; B32B 21/02; B32B 23/02; B32B 27/02; B32B 9/00

(52) U.S. Cl. 428/403; 428/357

(57) ABSTRACT

The invention relates to a system, security elements and security features with colour effects, which can be produced by vapour deposition in a PVD or CVD process, processes for their production and their use.

The invention relates to a system, security elements and security features with colour effects, which can be produced by vapour deposition in a PVD or CVD process, processes for their production and their use.

Data carriers and valuable documents, such as banknotes, identity papers or the like, or packaging materials for sensitive goods such as electronic components, pharmaceutical products and the like are provided with security elements, for example in the form of threads, strips, tapes, patches or other formats, in order subsequently to be able to check their authenticity. The information and codes, for example electrical conductivity, magnetic codes, holograms or diffraction structures, symbols, patterns, cutouts, coloured and/or luminescent effects or sequences and the like possessed by the security features are increasingly becoming more complex and more expensive in order to achieve increased security against forgery and making exact copying virtually impossible.

However, the complex information, codes and the like possessed by the security features are generally difficult to detect optically or the ability to detect them optically or check them is not desired. Normally, the security features can only be read expensively by a machine and in this way the authenticity of the corresponding data carrier, the valuable document or the packs can be checked.

However, it is often advantageous to apply an additional optically unambiguous and detectable feature to the data carrier, the valuable document or the pack, which is not only used as a possibly additional security feature but also permits an unambiguous assignment of the data carrier, valuable document or the pack, for example to a specific place of origin, a specific value or a specific content, a specific brand or the like.

It was an object of the invention to propose a system of security elements which, if appropriate, in addition to the codes and elements described above, permits a specific defined property to be allocated to a data carrier, a banknote or the like by means of a specific coloured effect which can be detected easily.

The object of the invention is, therefore, a system for the optically simply detectable and unambiguously assignable identification of data carriers, valuable documents and/or packs and the like, characterized in that the data carrier, the valuable document and/or the pack is provided with a full-area or partial coating which, by means of its coloration or by means of the colour effect produced and/or by means of its dimension and/or situation and/or its structure, permits an unambiguous assignment of the data carrier, of the valuable document and/or of the pack to a defined property.

A further object of the invention is security elements to be applied to and/or at least partly embedded in data carriers, valuable documents and/or packs and the like, characterized in that the security elements are provided with a coating which, by means of its coloration or by means of the colour effect produced and/or by means of its dimension and/or situation and/or its structure, permits an unambiguous assignment of the data carrier, of the valuable document and/or of the pack to a defined property.

A further object of the invention is a thin sheet material, characterized in that it is provided with a coating which, by means of its coloration or by means of the colour effect produced respectively and/or by means of its dimension and/or situation and/or its structure, permits an unambiguous assignment to a defined property.

The system according to the invention comprises security elements having a defined coloured, if appropriate also metallic or apparently metallic or reflective, coating which, by means of the different colour effects, permits an unambiguous assignment of the data carrier, of the valuable document and/or of the pack to a defined property

Thus, for example, a security element corresponding to the invention, which is provided with such a coating with different colour effects as a security feature, can be applied to valuable documents in accordance with their value and/or at least partly embedded in the said documents.

The hue or the colour effect produced by the coating then permits an unambiguous assignment to the value of the valuable document.

In this case, it is possible, for example depending on the value of a banknote, to use different colours or colour effects or else, for example within a banknote series, different graduations or intensities of the same colour.

Furthermore, colour matching of the coating to the colour of the banknote can be carried out.

In the case of packs, this defined colour effect can, for example, identify the content and/or the place of origin of the product unambiguously.

The coating can additionally have further features, for example cutouts in the form of patterns, symbols, lines, guilloches and the like. Furthermore, the coating can be present as a solid tone, in half-tone, or rastered.

Furthermore, the coating according to the invention can be combined with further layers having functional and/or decorative features, for example layers having magnetic and/or conductive properties, layers having optically active structures, for example surface reliefs, diffraction gratings and/or holograms.

The coating with the abovedescribed defined colour effect can be present over the entire area or partially and is preferably applied to a carrier substrate by means of a PVD or CVD process.

In this case, a carrier substrate, which can already have one or more structured or unstructured layers, is treated by means of an in-line plasma, corona or flame process and the coating according to the invention is then applied either in-line or in a subsequent process step in a PVD or CVD process.

The carrier substrate is preferably treated by means of an in-line plasma (low pressure or atmospheric plasma), corona or flame process. By means of a high-energy plasma, for example an Ar or Ar/O₂ plasma, the surface is cleaned of any scumming residues which may be present. In this case, for a partial application, the necessary sharp delimitation of the contours of the cutout, which is needed for the necessary precision of decoding, is also achieved. In the process, polar groups standing on end are produced at the surface. This improves the adhesion of metals and the like to the surface.

If appropriate, at the same time as the application of the plasma or corona or flaming treatment, a thin metal or metal oxide layer can be applied as an adhesion promoter, for example by means of sputtering or vapour deposition. In this case, Cr, Al, Ag, Ti, Cu, TiO₂, Si oxides or chromium oxides are particularly suitable. This adhesion promoting layer generally has a thickness of 0.1 nm-5 nm, preferably 0.2 nm-2 nm, particularly preferably 0.2 to 1 nm.

As a result, the adhesion of the partial or full-area coatings is improved further.

Metals and their compounds, for example oxides, sulphides, or alloys, are particularly suitable.

Suitable metals are, for example, Al, Cu, Fe, Ag, Au, Cr, Ni, Zn, Cd, Bi and the like. Suitable as metal compounds are, for example, oxides or sulphides or chromates of metals, in particular TiO₂, Cr oxides, ZnS, ITO, Bi oxide, ATO, FTO, ZnO, Al₂O₃, Zn chromate, Fe oxides, CuO and the like or silicon oxides. Suitable alloys are, for example, Cu—Al alloys, Cu—Zn alloys, iron alloys, steel, for example Cr—Ni steel and the like.

If appropriate, the vapour-deposited metal compounds can also be doped with rare earth metals. As a result, in addition to the desired colour, a luminescence effect is additionally obtained. Furthermore, for example, copper colour pigments, such as azurite or malachite, can be vapour-deposited.

The layer thickness of the vapour-deposited layer substantially depends on the desired colour. For example, a Bi oxide layer about at least 160-230 nm thick, and also a TiO₂ layer appears transparent blue, a ZnS layer appears green, a Cd layer appears yellow, an Al layer in conjunction with Fe₂O₃ appears orange to purple-red, the hue being controlled by the input of energy. If Cu is vapour-deposited under excess oxygen, the coating appears blue. Vapour-deposited ZnO appears transparent and reddish.

The coating is applied in a PVD or CVD process. In a PVD process, the coating is deposited on the carrier substrate under a vacuum (up to 10^{31 12} mbar, preferably 10⁻² to 10⁻⁶ mbar) at a temperature which depends on the vapour pressure and the thickness of the coating to be applied, for example by means of thermal vapour deposition, arc or electron beam vapour deposition. One further possibility is to apply the coating by means of AC or DC sputtering, the appropriate process being selected on the basis of the layer to be applied and the material used. If a plurality of layers are to be applied, separating layers, for example insulators, polymer layers and the like, can be applied between the individual layers, in-line or in a separate process step.

In a CVD process, by mixing the substance to be applied with a gas plasma or with an activation gas, for example CO, CO₂, oxygen, silanes, methane, ammonia and the like, a chemical reaction is brought about by means of an ion beam and the substance produced is deposited on the carrier. In this way, a plurality of reactive layers can be applied simultaneously or in parallel, a colour effect is produced on the carrier substrate.

If the coating is to be applied partially to the carrier substrate, in a first step, an applied colour that is soluble in a solvent is applied to one or both sides of the carrier substrate, in a second step, this layer is treated by means of an in-line plasma, corona or flame process and in the third step, the coating is applied by means of a PVD or CVD process, whereupon, in a fourth step, the applied colour is removed by means of a solvent, possibly combined with a mechanical action.

The application of the applied colour can be carried out by means of any desired process, for example by means of gravure printing, flexographic printing, screen printing, digital printing and the like. The colour used or the colour varnish used is soluble in a solvent, preferably in water, but a colour that is soluble in any desired solvent, for example in alcohol, esters and the like, can also be used. The colour or the colour varnish can be conventional compositions based on natural or artificial macromolecules. The soluble colour can be pigmented or non-pigmented. All known pigments can be used as pigments. Particularly suitable are TiO₂, ZnS, kaolin and the like.

The treatment already described above by means of an in-line plasma (low pressure or atmospheric plasma), corona or flame process and the application of the coating is then carried out.

The coloured layer is then removed by a suitable solvent, which is matched to the composition of the coloured layer. The applied colour is preferably water-soluble. If appropriate, the solution can be assisted by mechanical action.

In order to improve the initial dissolving of the covered coloured layer further, a thin pigmented coloured layer or a pure pigment layer can also be applied over the entire area or in register, the thickness of this layer being about 0.01-5 μm.

As a result of dissolving the applied colour with the regions of the coating located over the applied colour, the desired partial coating is obtained.

Suitable as a carrier substrate for the security feature according to the invention are, for example, carrier films, preferably flexible plastics films, for example of PI, PP, MOPP, PE, PPS, PEEK, PEK, PEI, PSU, PAEK, LCP, PEN, PBT, PET, PA, PC, COC, POM, ABS, PVC. The carrier films preferably have a thickness of 5-700 μm, preferably 5-200 μm, particularly preferably 5-50 μm.

Dyed, colour-varnished or demetallized plastic films with colour effects can also be used as the carrier substrate.

Furthermore, metal foils, for example Al, Cu, Sn, Ni, Fe or stainless-steel foils with a thickness of 5-200 μm, preferably 10 to 80 μm, particularly preferably 20-50 μm, can be used as a carrier substrate. The foils can also be surface treated, coated or laminated, for example to plastics, or varnished.

Furthermore, paper or composites with paper, for example, composites with plastics with a grammage of 20-500 g/m², preferably 40-200 g/m², can be used as carrier substrates.

Furthermore, fabrics or nonwovens, such as endless fibre nonwovens, staple fibre nonwovens and the like, which may possibly be needled or calendered, can be used as carrier substrates. Such fabrics or nonwovens preferably consist of plastics, such as PP, PET, PA, PPS and the like, but fabrics or nonwovens of natural, possibly treated fibres, such as viscose fibre nonwovens, can also be used. The fabrics or nonwovens used have a grammage of about 20 g/m² to 500 g/m². If appropriate, the fabrics or nonwovens can be surface-treated.

However, the carrier substrate can also already additionally have a varnish or coloured layer, which can be unstructured or structured, for example embossed. The varnish layer can, for example, be a transfer varnish layer with release properties, it can be cross-linked or cross-linkable by means of radiation, for example UV radiation, and can be finished in a scratch-resistant and/or antistatic manner. Both aqueous and solid varnish systems are suitable, in particular including varnish systems based on polyester acrylate or epoxy acrylate, colophony, acrylate, alkyd, melamine, PVA, PVC, isocyanate, urethane systems, which can be conventionally or reactively curing (mixture or radiation curing).

In each case, an extremely wide range of compositions can be used as the colour or varnish layers. The composition of the individual layers can vary, in particular in accordance with their task, that is to say whether the individual layers are to serve only decorative purposes or are to be a functional layer or whether the layer is to be both a decorative and a functional layer.

These layers can be pigmented or non-pigmented. The pigments which can be used are all known pigments, such as titanium dioxide, zinc sulphide, kaolin, ITO, ATO, FTO, aluminium, chromium and silicon oxides and also coloured pigments. In this case, varnish systems containing solvent and also systems without solvent can be used.

Various natural or synthetic binders are suitable as binders.

These further functional layers, already present on the carrier substrate or applied subsequently, can, for example, have specific chemical, physical and also optical properties.

The optical properties of a further layer may be influenced by visible dyes or pigments, luminescent dyes or pigments which fluoresce or phosphoresce in the visible, in the UV range or in the IR range, or effect pigments, such as liquid crystals, pearl lustre, bronzes and/or multilayer colour-change pigments and heat-sensitive colours or pigments. These can be used in all possible combinations. In addition, phosphorescent pigments can also be used on their own or in combination with other dyes and/or pigments.

Furthermore, electrically conductive layers can also be present on the substrate or applied subsequently, for example electrically conductive polymer layers or conductive colour or varnish layers.

In order to adjust the electrical properties, the colour to be applied or the varnish to be applied can have added to it, for example, graphite, carbon black, conductive organic or inorganic polymers, metal pigments (for example copper, aluminium, silver, gold, iron, chromium and the like), metal alloys such as copper-zinc or copper-aluminium or else amorphous or crystalline ceramic pigments such as ITO, ATO, FTO and the like. Furthermore, doped or non-doped semiconductors such as silicon, germanium, or doped or non-doped polymer semiconductors or ion conductors such as amorphous or crystalline metal oxides or metal sulphides can be used as an additive. Furthermore, in order to adjust the electrical properties of the layer, polar or partially polar compounds such as surfactants, or non-polar compounds such as silicone additives or hygroscopic or non-hygroscopic salts can be used or added to the varnish.

As a layer with electrical properties, a full-area or partial metal layer can also be applied, it being possible for the partial application to be carried out by means of an etching process (application of a full-area metal layer and subsequent partial removal by etching) or by means of a demetallization process.

If a demetallization process is used, in a first step, a colour that is soluble in a solvent (if appropriate in the form of an inverse code) is preferably applied, and then, if appropriate following activation of the carrier substrate by means of a plasma or corona treatment, the metallic layer is applied, after which the soluble colour layer is dissolved by means of treatment with a suitable solvent, together with the metallization present in these regions.

Furthermore, an electrically conductive polymer layer can also be applied as an electrically conductive layer. The electrically conductive polymers can be, for example, polyaniline or polyethylene dioxythiophene. PEDT/TS is particularly preferably used as an electrically conductive polymer.

It is also possible to add carbon black or graphite, for example, to the magnetic colour used, by which means a layer which is simultaneously magnetic and also electrically conductive can be produced particularly advantageously in a defined coding in accordance with the method of the invention.

Furthermore, further surface relief structures, for example diffraction gratings, holograms and the like, are suitable as additional security features, it being possible for these structures, if appropriate, also to be metallized or partially metallized.

In order to produce surface structures of this type, first of all UV-curable varnish which can be deep drawn is applied. Then, for example, a surface structure can be produced by moulding a female die in this varnish which, at the time of the moulding, has pre-cured as far as the gel point, the radiation-curable varnish then being cured completely following the application of the surface structure.

As a result of the use of the UV-curable varnish, following the curing of layers applied thereto, a surface structure which may possibly be introduced is also stable even under temperature stress.

The radiation-curable varnish can be, for example, a radiation-curable varnish system based on a polyester, an epoxy or polyurethane system which contains two or more different photo initiators familiar to those skilled in the art which, at different wavelengths, are able to initiate curing of the varnish system to a different extent. For example, a photo initiator can be capable of activation at a wavelength of 200 to 400 nm, the second photo initiator then at a wavelength of 370 to 600 nm. A sufficient difference should be maintained between the activation wavelengths of the two photo initiators in order that excessively high excitation of the second photo initiator does not take place while the first is being activated. The range in which the second photo initiator is excited should lie in the transmission wavelength range of the carrier substrate used. For the main curing (activation of the second photo initiator), electron radiation can also be used.

The radiation-curable varnish used can also be a varnish which can be diluted with water. Varnish systems based on polyester are preferred.

Furthermore, the coating according to the invention can additionally be combined with a layer which brings about a colour tilting effect, it then being possible for the coating to function as a layer that reflects electromagnetic waves.

In this case, the coating bringing about the colour tilting effect in each case has at least one layer that reflects electromagnetic waves, a spacer layer (for example one or more polymer layers) and a layer formed of metallic clusters. A partial or full-area layer that reflects electromagnetic waves, for example the coating according to the invention, and then one or more partial and/or full-area polymer layers of defined thickness are applied to the carrier substrate. Applied to this spacer layer is a layer formed of metallic clusters, which is produced by means of a vacuum process or from solvent-based systems.

Furthermore, the security elements or thin sheet materials according to the invention can be provided with a protective varnish layer on one or both sides. The protective varnish can be pigmented or non-pigmented, it being possible for all known pigments or dyes, for example TiO₂, ZnS, kaolin, ATO, FTO, aluminium, chromium und silicon oxides or, for example, pthalocyanine blue, i-indolide yellow, dioxazine violet to be used as pigments. Furthermore, luminescent dyes or pigments which fluoresce or phosphoresce in the visible, in the UV range or in the IR range, effect pigments such as liquid crystals, pearl lustre, bronzes and/or multilayer colour-change pigments and heat-sensitive colours and pigments can be added. These can be used in all possible combinations. In addition, luminescent pigments can also be used on their own or in combination with other dyes and/or pigments.

Furthermore, the security element according to the invention can be provided on one or both sides with a hot-melt or cold-seal adhesive or a self-adhesive coating for application to or embedding in a substrate, it being possible for these adhesives or adhesive coatings to be pigmented.

Furthermore, the security element according to the invention can be laminated with one or more carrier substrates which, if appropriate, have functional and/or decorative layers, using a lamination adhesive, it being possible for the lamination adhesive also to be pigmented.

It is possible to combine the system according to the invention in combination with further security features, if appropriate at another point on the valuable document or the pack.

For example, the combination with an at least partly embedded security thread which, for example, has positive or negative cutouts, is conceivable.

In one embodiment, the security element according to the invention is applied in accurate register with the feature or features located in the carrier, for example lines, cutouts, optical, electrical, magnetic or optically active structures and the like, so that the security features located on the security element form a complete authenticity or identification feature only after application to or incorporation in the carrier. Furthermore, by means of the above described accurate-register application or incorporation of the security element, a continuation or repetition of the security feature already present on the carrier can be carried out, which means that unambiguous checking of the authenticity or identity can be carried out.

The system according to the invention can be used as an easily detectable security feature for authenticity or identification feature on data carriers, in particular valuable documents, such as identity papers, and cards, banknotes, to packaging materials in the pharmaceutical, electronic or foodstuffs industry

In the case of packs, advantageously both the pack and the product packed therein and, if appropriate, information packed with it, such as technical data sheets, instructions for use, fitting instructions and the like, are provided with a coating having a defined colour effect. As a result, both the intactness of the pack and also any possible manipulation of the contents of the pack can be determined.

1. System for the optically simply detectable and unambiguously assignable identification of data carriers, valuable documents and/or packs and the like, characterized in that the data carrier, the valuable document and/or the pack is provided with a coating which, by means of its coloration or by means of the colour effect produced and/or by means of its dimension and/or situation and/or its structure, permits an unambiguous assignment of the data carrier, of the valuable document and/or of the pack to a defined property.

2. Security elements for application to and/or for at least partial embedding in data carriers, valuable documents and/or packs and the like, characterized in that the security elements are provided with a coating as security feature which, by means of its coloration or by means of the colour effect produced and/or by means of its dimension and/or situation and/or its structure, permits an unambiguous assignment of the data carrier, of the valuable document and/or of the pack to a defined property.

3. Security elements according to claim 2, characterized in that the coating is applied by means of a PVD or CVD process.

4. Security elements according to claim 2, characterized in that the coating consists of metals, their compounds or their alloys.

5. Security elements according to claim 2, characterized in that the coating consists of Al, Cu, Fe, Ag, Au, Cr, Ni, Zn, Cd, Bi, TiO₂, Cr oxides, ZnS, ITO, Bi oxide, ATO, FTO, ZnO, Al₂O₃, Zn chromate, Fe oxides, CuO, Cu—Al alloys, Cu—Zn alloys, iron alloys, steel, colour pigments, azurite or malachite and the like.

6. Security elements according to claim 2, characterized in that the security elements have further functional and/or decorative layers.

7. Security elements according to claim 6, characterized in that they additionally have one or more electrically conductive layers and/or layers with magnetic properties and/or layers with structures active in diffraction and/or layers with positive or negative printing.

8. Security elements according to claim 2, characterized in that they are provided with a protective varnish layer on one or both sides.

9. Security elements according to claim 8, characterized in that the protective varnish layer is pigmented.

10. Security elements according to claim 2, characterized in that the security elements are laminated to one or more carrier substrate(s) which has/have the possibly functional and/or decorative layers.

11. Security elements according to claim 10, characterized in that the lamination adhesive is pigmented.

12. Security elements according to claim 2, characterized in that the security elements are provided on one or both sides with a hot-melt or cold-seal adhesive or a self-adhesive coating.

13. Security elements according to claim 12, characterized in that the adhesive or the self-adhesive coating is pigmented.

14. Thin sheet material, characterized in that it is provided with a coating which, by means of its coloration or by means of the colour effect produced and/or by means of its dimension and/or situation and/or its structure, permits an unambiguous assignment to a defined property.

15. Thin sheet material according to claim 14, characterized in that the coating is applied by means of a PVD or CVD process.

16. Thin sheet material according to claim 14, characterized in that the coating consists of metals, their compounds or their alloys.

17. Thin sheet material according to claim 16, characterized in that the coating consists of Al, Cu, Fe, Ag, Au, Cr, Ni, Zn, Cd, Bi, TiO₂, Cr oxides, ZnS, ITO, Bi oxide, ATO, FTO, ZnO, Al₂O₃ Zn chromate, Fe oxides, CuO, Cu—Al alloys, Cu—Zn alloys, iron alloys, steel, colour pigments, azurite or malachite and the like.

18. Thin sheet material according to claim 14, characterized in that the thin sheet material has further functional and/or decorative layers.

19. Thin sheet material according to claim 18, characterized in that the thin sheet material additionally has one or more electrically conductive layers and/or layers with magnetic properties and/or layers with structures active in diffraction and/or layers with positive or negative printing.

20. Thin sheet material according to claim 14, characterized in that the thin sheet material is provided with a protective varnish layer on one or both sides.

21. Thin sheet material according to claim 20, characterized in that the protective varnish layer is pigmented.

22. Thin sheet material according to claim 14, characterized in that the thin sheet material is laminated to one or more carrier substrate(s), which possibly has/have functional and/or decorative layers.

23. Thin sheet material according to claim 22, characterized in that the lamination adhesive is pigmented.

24. Thin sheet material according to claim 14, characterized in that the thin sheet material is provided on one or both sides with a hot-melt or cold-seal adhesive or a self-adhesive coating.

25. Thin sheet material according to claim 24, characterized in that the adhesive or the self-adhesive coating is pigmented.

26. Valuable documents, packs and the like which have a security element according to claim 2.

27. Use of the security elements according to claim 2, if appropriate following tailoring, as security features in data carriers, in particular valuable documents such as identity papers, cards, banknotes or labels, seals on or as packaging material, for example in the pharmaceutical, electronic and/or foodstuffs industry, for example in the form of blister films, folding boxes, covers, film packs.

28. Use of the thin sheet material according to claim 14, if appropriate following tailoring, as security features in data carriers, in particular valuable documents such as identity papers, cards, banknotes or labels, seals on or as packaging material, for example in the pharmaceutical, electronic and/or foodstuffs industry, for example in the form of blister films, folding boxes, covers, film packs.

29. Use of the system according to claim 1 for colour identification of the value or other properties of a valuable document, of a product and/or of a pack.

30. Valuable documents, packs and the like which have a system according to claim 1.
